(19) United States
(12) Patent Application Publication
(10) Pub. No.: US 2005/0215667 A1
(43) Pub. Date: Sep. 29, 2005

(54) Curable composition

(76) Inventors: Kenji Shimaoka, Tokyo (JP); Shigeshi Aoyama, Tokyo (JP); Takuji Ishimoto, Wako-City (JP)

Correspondence Address: ARENT FOX PLLC, 1050 CONNECTICUT AVENUE, N.W., SUITE 400, WASHINGTON, DC, 20036, US

(21) Appl. No.: 11/086,650

(22) Filed: Mar. 23, 2005

(30) Foreign Application Priority Data
Mar. 25, 2004 (JP) 2004-089527

(51) Int. Cl. C08F 2/00

(52) U.S. Cl. 523/201

(57) ABSTRACT

The present invention provides a thermally crosslinking type curable composition having the following excellent performance and properties: it needs no poly vinyl chloride resin, and exhibits excellent adhesiveness even to aluminum alloy materials and the like. The curable composition is characterized in that a diluent and an adhesion promoter are compounded with a composition containing uncrosslinked type and/or partially crosslinked type synthetic rubber, a plasticizer, a filler and a core-shell type acrylic resin. As the diluent, there are preferably used paraffinic or naphthenic hydrocarbons obtained by distillation of crude oil, or chemically synthesized hydrocarbons which are the second or third class petroleum having a molecular weight of 200 or less.

### BACKGROUND OF THE INVENTION

1. Field of the Invention

The present invention relates to a thermally crosslinking type rubber composition as a curable composition, and, particularly, to a curable composition which is obtained by compounding a diluent and an adhesion promoter with a composition containing synthetic rubber having a crosslinkable double bond and a core-shell type acrylic resin, thereby has good adhesion to an alloyed aluminum material which has been surface-treated with oil and is preferably used as a sealing material or an adhesive.

2. Description of the Related Art

A synthetic rubber composition having a crosslinkable double bond has been used in applications such as vibrationproof between steel plates and reinforcing adhesion. Rust preventive oil and press oil are applied to the surface of a steel plate to impart rust preventive characteristics and processability to the steel plate; therefore it is required for an adhesive to have fixable characteristics without slippage or sagging, and configuration retentivity in an uncured state because the adhesive is exposed to shower for washing rust preventive oil and the like before the adhesive is heat cured. There is also required sufficient adhesiveness to the steel plate after the adhesive is heat cured. In order to fulfill these requirements, there have been so far used adhesives containing a poly vinyl chloride resin, synthetic rubber, a filler, a plasticizer and the like as essential components.

A poly vinyl chloride resin is relatively inexpensive and ensures tough characteristics, and hence is used in a variety of industries and applications. For example, as to the mixing effect of the poly vinyl chloride resin in an adhesive for automobile use, the requirements differing every part where an adhesive is used can be fulfilled easily by controlling the amount of the poly vinyl chloride resin to be mixed. However, it is difficult to select a material having the same effect as the poly vinyl chloride resin. Nowadays, when scrapped automobiles are incinerated, there are generated dioxins harmful to the environment; therefore there has been a stronger demand for a sealing material composition using no poly vinyl chloride resin in the adhesive. For this, an acrylic resin is examined as a substitution for the poly vinyl chloride resin (see, for example, JP-A No. 7-233299 and Japanese Patent No. 3464730) and has been already put to practical use in the field of undercoats used for a painting process in an auto assembly plant. However, since high wash off resistance is required in a welding process, it is difficult to use an acrylic sol as it stands.

Substitution of an aluminum material having a low specific gravity for a conventional steel plate is underway in various fields; in an automobile field, the aluminum material reduces the weight of an automobile body to thereby improve fuel consumption efficiency, thereby largely contributing to reduction in the amount of exhaust carbon dioxide. As aluminum materials for an automobile, 5000 type or 6000 type aluminum alloy materials are mainly used and each surface of these aluminum alloy materials is treated using a press oil for exclusive use to raise press molding ability. These aluminum alloy materials are usually difficult to be adhered using an adhesive and it is therefore desired to develop an adhesive excellent in adhesiveness.

It is an object of the present invention to provide a curable composition which contains no poly vinyl chloride resin, has wash off resistance and exhibits excellent adhesiveness to aluminum alloy materials or the like.

### SUMMARY OF THE INVENTION

The present inventors have made earnest studies to provide the above curable composition, and as a result, found that a core-shell type acrylic resin put to practical use as an acrylic sol is applied to a composition using synthetic rubber as a major component to thereby obtain a material which does not require to use a specific plasticizer together, has a great cost merit and high wash off resistance. This is attained even in the case of a general-purpose plasticizer by securing viscosity stability using a resin of gelling with high energy in the shell part and by obtaining tough characteristics using a resin of gelling with low energy in the core part. Moreover, the present inventors have also found the fact that using paraffinic or naphthenic hydrocarbons obtained by distillation of crude oil or a chemically synthesized compound as a diluent, and a combination of an epoxy resin and a latent curing agent as an adhesion promoter, there is available a curable composition exhibiting high adhesion to such an aluminum alloy material to which press oil is applied.

The curable composition of the present invention comprises uncrosslinked type and/or partially crosslinked type synthetic rubber, a plasticizer, a filler, a core-shell type acrylic resin, a diluent and an adhesion promoter. As the above diluent, there are preferably used paraffinic or naphthenic hydrocarbons obtained by distillation of crude oil or chemically synthesized hydrocarbons which are the second or third class petroleum having a molecular weight of 200 or less. The above adhesion promoter is preferably a combination of an epoxy resin and a latent curing agent.

A thermally crosslinking type rubber composition which is the curable composition of the present invention is produced by compounding a diluent and an adhesion promoter with a composition containing a uncrosslinked type and/or partially crosslinked type synthetic rubber, a plasticizer, a filler and a core-shell type acrylic resin. The curable composition has the following large effects on performance and properties: it needs no poly vinyl chloride resin to be less harmful to the environment, and exhibits excellent adhesiveness even to aluminum alloy materials and the like, which leads to advantages that the range of applications of aluminum alloy materials is widened and the tare is further reduced.

### DETAILED DESCRIPTION OF THE INVENTION

Embodiments of the present invention will be explained below. These embodiments are, however, shown only for illustrative purposes and it is needless to say that various modifications and variations may be made without departing from the technical spirit of the present invention.

An acrylic resin is used in a curable composition of the present invention in place of a poly vinyl chloride resin to make it possible to easily control the properties of the curable composition. The structure of the acrylic resin is obtained by regulating each thickness of monomers having different compositions step by step by seed polymerization in which a monomer is absorbed in and polymerized with a seed. The monomer component includes a core part that is constituted of at least one of ethylmethacrylate, n-butylmethacrylate, t-butylmethacrylate and ethylacrylate, and a shell part that is constituted of-at least one of methacrylic acid and acrylic acid. As the acrylic resin, one having an average molecular weight of 5 to 2,000,000 and an average particle diameter of 0.1 to 100 μm is used.

The diluent in the curable composition of the present invention makes it possible to improve wettability to the surface of a steel plate or aluminum alloy material to which an antirust oil and the like are applied, and to improve adhesiveness to an adherend. The diluent is a paraffinic or naphthenic hydrocarbon obtained by distillation of crude oil or a chemically synthesized compound. There are preferably used hydrocarbons which are the second class petroleum or the third class petroleum having a molecular weight of 200 or less and a flash point of 21° C. or less.

The adhesion promoter in the curable composition of the present invention makes it possible to secure stable adhesion to 5000 type or 6000 type aluminum alloy materials that are generally adhered with difficulty. As the adhesion promoter, there are exemplified bisphenol A type epoxy resins, bisphenol F type epoxy resins and epoxy resins modified with liquid NBR or urethane polymers. There are particularly preferable bisphenol A type epoxy resins which have an epoxy equivalent of the order of 180 to 190 in view of the balance between performance and cost.

As a latent curing agent for the epoxy resin, there are exemplified dicyandiamides, dihydrazides, imidazoles and dimethyl ureas. The amount of the latent curing agent to be compounded with the epoxy resin differs depending on the type of the curing agent and is determined corresponding to the types of the epoxy resin and the curing agent to be used.

Besides the above adhesion promoter, well known adhesion promoters can be widely used without any particular limitation. To be concrete, as the adhesion promoter there are preferably exemplified phenolic resins, acrylic monomers, polyamide resins, modified acrylic resins, silane coupling agents and block isocyanates. Also, a curing agent and a catalyst for each of these compounds may be used.

Although no particular limitation is imposed on a compounding proportion of the adhesion promoter, it is usually used in a proportion of 10 to 300 parts by weight and preferably 10 to 200 parts by weight. The adhesion promoter may be used individually or in combination thereof. For example, a combination of block urethanes, acrylic monomers and organic peroxides may be used in an amount of 0.5 to 10 parts by weight together with a combination of the epoxy resin and the latent curing agent.

As the uncrosslinked type synthetic rubber and partially crosslinked type synthetic rubber in the curable composition of the present invention, there may be specifically utilized partially crosslinked type rubber (rubber which is partially crosslinked in advance using a crosslinking agent such as divinylbenzene or sulfur), reclaimed rubber regenerated by desulfurizing natural rubber, styrene-butadiene copolymer rubber (SBR) and the like, and uncrosslinked type synthetic rubber.

As the uncrosslinked type synthetic rubber, there may be utilized diene type synthetic rubber such as an acrylonitrile/isoprene copolymer rubber (NIR), acrylonitrile/butadiene copolymer rubber (NBR), styrene/butadiene copolymer rubber (SBR), isoprene rubber (IR) and butadiene rubber (BR). The diene type synthetic rubber may be selected in the form of either a liquid or a solid without any limitation. As the diene type synthetic rubber, there may be utilized modified NBR, modified BR and the like to which a carboxylic group, a hydroxyl group or other groups is added.

These uncrosslinked type synthetic rubber and partially crosslinked type synthetic rubber may be used individually or in any combination thereof. Although no particular limitation is imposed on the amount of the synthetic rubber to be added, it is generally on the order of 2 to 30% by weight and preferably 5 to 15% by weight based on the total amount of the curable composition of the present invention.

As the plasticizer in the curable composition of the present invention, a wide range of compounds known as a plasticizer may be used without any particular limitation and there are exemplified phthalates such as BBP, DBP, DHP, DOP, DINP and DIDP, benzoates, adipates, glutarates, phosphates, polyester type plasticizers, epoxy type plasticizers, process oil and liquid paraffin. Among these plasticizers, DIDP, DINP and process oil are preferable. Although no particular limitation is imposed on the amount of the plasticizer to be added, it is usually 100 to 600 parts by weight and preferably 200 to 500 parts by weight based on 100 parts by weight of the synthetic rubber of the present invention (the amount of the synthetic rubber is unchanged, so this description will be omitted hereinafter). The plasticizer may be used either individually or in combination thereof.

As the filler in the curable composition of the present invention, a wide range of compounds known as a filler may be used without any particular limitation and there are exemplified calcium carbonate, talc, clay, aluminum hydroxide, calcium hydroxide, magnesium hydroxide, mica, alumina, magnesium carbonate, silica powder, cellulose powder, powder of resin such as polyethylene and metal powder. Moreover, as the filler, a hollow filler may be used and there are exemplified an organic hollow filler such as polyester resin, phenol resin, polyolefin resin, amino resin, vinylidene chloride/acrylonitrile copolymer resin and silicone resin, and an inorganic hollow filler such as sirasu, fly ash, alumina, glass or carbon. The filler may be used either individually or in combination thereof. Although no particular limitation is imposed on the amount of the filler to be added, it is usually 300 to 600 parts by weight and preferably 350 to 550 parts by weight.

It is preferable to add a vulcanizing agent or a vulcanizing accelerator as a crosslinking agent for the synthetic rubber into the curable composition of the present invention. As the above vulcanizing agent in the curable composition of the present invention, there are exemplified a poly-p-dinitrobenzene, ammonium benzoate, N-N′-m-phenylenedimaleimide, p-quinonedioxime, p-p′-dibenzoylquinonedioxime, 4-4′-dithiodimorpholine, metal oxides and sulfur or sulfur type compounds (in the present invention, sulfur and sulfur type compounds are collectively called sulfur type compounds. Specific examples of the sulfur type compounds include simple sulfur, sulfur chloride, sulfur dichloride, diethylthiourea, dibutylthiourea, trimethylthiourea, diorthotolylthiourea, morpholine disulfide, alkylphenol disulfide, tetramethylthiuram disulfide and selenium dimethyldithiocarbamate). Among these sulfur type compounds, particularly, those are preferable sulfur type compounds which can crosslink synthetic rubber by heating.

The vulcanizing agent may be used either individually or in combination thereof. Although no particular limitation is imposed on the amount of the vulcanizing agent to be added, it is usually 1 to 100 parts by weight and preferably 1 to 50 parts by weight.

As the vulcanizing accelerator, there are exemplified aldehyde ammonia type compounds such as hexamethylene tetramine; aldehyde amine type compounds such as n-butyl aldehyde aniline; thiourea type compounds such as N-N′-diphenyl thiourea, trimethyl thiourea and N,N′-diethyl thiourea; guanidine type compounds such as 1,3-diphenyl guanidine, di-o-tolyl guanidine, 1-0-tolylbiguanide and dicatechol borate di-o-tolyl guanidine salt; thiazole type compounds such as 2-mercapto benzothiazole, dibenzothiadisulfide, 2-mercapto benzothiazole metal salt, 2-mercapto benzothiazole cyclohexyl amine salt, 2-(N,N′-diethyl thiocarbamoylthio) benzothiazole and 2-(4′-morpholinodithio) benzothiazole; sulfenamide type compounds such as N-cyclohexyl-2-benzothiazolyl sulfenamide, N-tert-butyl-2-benzothiazolyl sulfenamide and N-oxydiethylene-2-benzothiazolyl sulfenamide; thiuram type compounds such as tetramethyl thiuram disulfide, tetraethyl thiuram disulfide, tetrabutyl thiuram disulfide, tetrakis (2-ethylhexyl) thiuram disulfide, tetramethyl thiuram monosulfide and dipentamethylene thiuram tetrasulfide; and dithiocarbamate type compounds such as piperidine pentamethylene dithiocarbamate, pipecoline pipecolil dithiocarbamate, zinc dimethyl dithiocarbamate, zinc diethyl dithiocarbamate, zinc dibutyl dithiocarbamate, zinc N-ethyl-N-phenyl dithiocarbamate, zinc N-pentamethylenedithiocarbamate, zinc dibenzyl dithiocarbamate, sodium diethyl dithiocarbamate, sodium dibutyl dithiocarbamate, copper dimethyl dithiocarbamate, ferric dimethyl dithiocarbamate and tellurium diethyl dithiocarbamate. The vulcanizing accelerator is used in a proportion of usually 1 to 100 parts by weight and preferably 1 to 50 parts by weight. The vulcanizing agent may be used either individually or in combination thereof.

The above vulcanizing agent and the vulcanizing accelerator may be further used together with a peroxide type compound such as ketone peroxide, diacyl peroxide, dialkyl peroxide, hydroperoxide, peroxyketal or alkyl perester.

In order to impart necessary characteristics for the purposes, there may be added known materials, which are usually added to synthetic rubber type compositions, such as a rubber reinforcing material, a metal activator, a scorch preventive, an antioxidant, a thermal stabilizer, a lubricant, a releasing agent, a colorant, a flame retardant, an antistatic agent and a processing aid.

As the rubber reinforcing material, there may used various carbon black such as FT, MT, SAF, SPF, GPF, FEF and MAF and powdery silicic acid. The rubber reinforcing material is used in an amount of usually 100 parts by weight or less and preferably 50 parts by weight or less.

As the metal activator, there may be used zinc oxide, magnesium oxide, zinc peroxide, calcium oxide and zinc salts of higher fatty acids. The metal activator is used in a proportion of usually 200 parts by weight or less and preferably 10 to 100 parts by weight.

### EXAMPLES

The present invention will hereinafter be described in more specific manner by way of the following examples that should be construed as illustrative rather than restrictive.

### Example 1

100 parts of “BR” as synthetic rubber, 500 parts by weight of “calcium carbonate” as a filler, 350 parts by weight of “DINP” as a plasticizer, 30 parts by weight of “a methyl methacrylate/butyl methacrylate copolymer resin (molecular weight: 800,000)” as a core-shell type acrylic resin, 40 parts by weight of “a bisphenol A type epoxy resin” as an adhesion promoter, 5 parts by weight of “dicyandiamide”, 10 parts by weight of “sulfur” and 10 parts by weight of “zinc oxide” as latent curing agents, and 40 parts by weight of “Exsol D80) as a diluent were uniformly dispersed with stirring to make a curable composition. That is, the synthetic rubber, the filler and the plasticizer were blended using a Banbury mixer and the blended product was transported to a kneader where other additives were mixed one by one to disperse them uniformly.

### Example 2

The same procedure was conducted in the same manner as in Example 1 except that the amount of the “acrylic resin” was increased to 60 parts by weight.

### Example 3

The same procedure was conducted in the same manner as in Example 1 except that, as the adhesion promoter, “a rubber modified epoxy resin” was substituted for the “bisphenol A type epoxy resin”.

### Comparative Example 1

The same procedures was conducted in the same manner as in Example 1 except that the diluent in Example 1 was not used herein.

### Comparative Example 2

The same procedure was conducted in the same manner as in Example 1 except that “F320” (manufactured by Zeon KASEI Co., Ltd. was substituted for the acrylic resin “a methyl methacrylate/butyl methacrylate copolymer resin (molecular weight: 800,000)” in Example 1.

### Comparative Example 3

The same procedure was conducted in the same manner as in Example 1 except that 200 parts by weight of “DINP” and 150 parts by weight of an adipic acid type polyester “PN-160” (manufactured by ASAHI DENKA CO., LTD.) were substituted for the plasticizer and 30 parts by weight of “F320” (manufactured by Zeon KASEI Co., Ltd.) was substituted for the acrylic resin.

### Comparative Example 4

The same procedure was conducted in the same manner as in Example 1 except that the adhesion promoter and the latent curing agent in Example 1 were not used.

### Comparative Example 5

The same procedure was conducted in the same manner as in Example 1 except that the synthetic rubber and the crosslinking agent in Example 1 were not used.

Each curable composition obtained above was subjected to the following performance evaluation test. The results are shown in Table 1.

1. Adhesiveness

The obtained curable composition was applied to test pieces of a CRS (cold roll steel) plate and an aluminum plate each coated with 2 g/m² of rust preventive oil and heat cured for 20 minutes in an oven kept at 170° C. After the cured composition film was cooled, the adhesiveness of the cured film was evaluated by nail peeling. Evaluation standard: ◯: cohesive failure, Δ: mixture of cohesive failure and adhesive failure, ×: adhesive failure.

2. Adhesive Strength

The obtained curable composition was applied to a CRS plate (25 mm×100 mm) with an area of 25 mm×25 mm and put into a chamber set to 170° C. for 20 minutes for baking. After the baked plate was cooled, the longitudinal shear strength thereof was measured at the tensile speed of 50 mm/min. Evaluation standard: \mathring{∘}: 500 kPa or more, ◯: 100 kPa or more, ×: less than 100 kPa.

3. Viscosity stability After Storing

The obtained curable composition was packed in an airtight container and was allowed to stand at 40° C. for one week. Then, the viscosity of the composition was measured at room temperature. Evaluation standard: ◯: viscosity changing rate is within 30%, Δ: viscosity changing rate is within 50%, ×: viscosity changing rate is more than 50%.

4. Wash Off Resistance

The obtained curable composition was applied to a CRS plate (70 mm width×150 mm length) coated with 2 g/m² of rust preventive oil with a semicircular form having a diameter of 10 mm and a length of 100 mm. The curable composition was sprayed with 40° C. warm water from a position 700 mm away from the steel plate at a hydraulic pressure of 19.6 kPa for one minute to observe bead forms. Evaluation standard: ◯: the significant change in form is not observed, ×: the significant change in form is observed.

5. Cost

Each example was relatively compared with Example 1 in the cost of raw materials. Evaluation standard, \mathring{∘}: the variation rate is within 5%, ◯: the variation rate is within 10%, ×: the variation rate is more than 10%.

TABLE 1

| | | Example | | | Comparative Example | | | | |
|---|---|---|---|---|---|---|---|---|---|
| | | 1 | 2 | 3 | 1 | 2 | 3 | 4 | 5 |
| Synthetic rubber | 1) | 100 | 100 | 100 | 100 | 100 | 100 | 100 | — |
| Filler | 2) | 500 | 500 | 500 | 500 | 500 | 500 | 500 | 500 |
| Plasticizer A | 3) | 350 | 350 | 350 | 350 | 350 | 200 | 350 | 150 |
| Plasticizer B | 4) | — | — | — | — | — | 150 | — | — |
| Acrylic resin A | 5) | 30 | 60 | 30 | 30 | — | — | 30 | 30 |
| Acrylic resin B | 6) | — | — | — | — | 30 | 30 | — | — |
| Epoxy resin A | 7) | 40 | 40 | — | 40 | 40 | 40 | — | 40 |
| Epoxy resin B | 8) | — | — | 40 | — | — | — | — | — |
| Curing agent | 9) | 5 | 5 | 5 | 5 | 5 | 5 | — | 5 |
| Vulcanizing agent | 10) | 10 | 10 | 10 | 10 | 10 | 10 | 10 | — |
| Vulcanizing accelerator | 11) | 10 | 10 | 10 | 10 | 10 | 10 | 10 | — |
| Diluent | 12) | 40 | 40 | 40 | — | 40 | 40 | 40 | 40 |

| | | | | | | | | | |
|---|---|---|---|---|---|---|---|---|---|
| Adhesiveness | Soft steel | ◯ | ◯ | ◯ | ◯ | ◯ | ◯ | X | X |
| | plate | | | | | | | | |
| | Aluminum | ◯ | ◯ | ◯ | X | ◯ | ◯ | X | X |

| | | | | | | | | |
|---|---|---|---|---|---|---|---|---|
| Adhesive strength | ◯ | ⊚ | ◯ | ◯ | X | ⊚ | X | ◯ |
| Viscosity stability after stored | ◯ | ◯ | ◯ | ◯ | ◯ | X | ◯ | ◯ |
| Wash off resistance | ◯ | ◯ | ◯ | ◯ | ◯ | ◯ | ◯ | X |
| Cost | ◯ | ◯ | ◯ | ◯ | ◯ | X | ◯ | ◯ |

The notes in Table 1 are as follows and the amount of each of the compounded materials is indicated by parts by weight.
1) “BR1220” manufactured by ZEON Corporation.
2) “NN-500” manufactured by NITTO FUNKA KOGYO K.K.
3) “DINP” manufactured by SEKISUI CHEMICAL CO., LTD.
4) “PN-160” manufactured by ASAHI DENKA CO., LTD.
5) “LP-3106” manufactured by MITSUBISHI RAYON CO., LTD.
6) “F320” manufactured by ZEON KASEI Co., Ltd.
7) “Adeka Resin EP4100 G” manufactured by ASAHI DENKA CO., LTD.
8) “Adeka Resin EPR4026” manufactured by ASAHI DENKA CO., LTD.
9) “CG-1200” manufactured by AIR PRODUCTS & CHEMICALS, INC.
10) “Sulfacs” manufactured by OUCHISHINKO CHEMICAL INDUSTRIAL CO., LTD.
11) “AZO-A” manufactured by SEIDO CHEMICAL INDUSTRY CO., LTD.
12) “Exsol D80” manufactured by EXXON MOBILE CORPORATION.

As is clear from the results of evaluation of each performance shown in Table 1, the curable composition of the present invention (Examples 1 to 3) exhibited such excellent results that it had high adhesiveness to various adherends, high shearing adhesive strength, a small viscosity change rate after storing and small variation of material costs for conventional products containing a poly vinyl chloride resin.

In Comparative Example 1, on the other hand, it was clarified that the composition had insufficient affinity to press oil used to aluminum alloy materials, so that the adhesiveness to the aluminum alloy materials was poor.

In Comparative Example 2 where the composition contained a conventional composition of a monolayer type acrylic resin, it was clarified that the composition had unsatisfactory compatibility with general-purpose DINP of a low cost, so that the composition was gelled insufficiently and a low level of shearing adhesive strength was shown.

In Comparative Example 3 where the composition contained a general-purpose monolayer type acrylic resin and a highly polar polyester type plasticizer, it was clarified that even the general-purpose monolayer type acrylic resin was sufficiently gelled, so that high shearing adhesive strength was obtained, but since the viscosity of the composition was raised after storing and the polyester type plasticizer was expensive, it was inferior in practical use.

The curable composition of the present invention that does not require addition of a poly vinyl chloride resin is preferably used for sealing materials and adhesives. Particularly, in case of applying the composition to vibrationproof and reinforcing adhesion between the outer and inner panels of an automobile, the uncured composition sufficiently exhibits fixing ability to a steel plate with an oily surface and shape retentivity against washing shower in a pretreatment process of electrodeposition coating. Also, the heat cured composition exhibits high adhesiveness to a steel plate or an aluminum alloy material with the result that the application of an aluminum alloy material in automobile fields can be expanded, so that it is expected that the composition of the present invention contributes to a further reduction in the tare of an automobile.

1. A curable composition, wherein a diluent and an adhesion promoter are compounded with a composition containing uncrosslinked type and/or partially crosslinked type synthetic rubber, a plasticizer, a filler and a core-shell type acrylic resin.

2. The curable composition according to claim 1, wherein as the diluent there are used paraffinic or naphthenic hydrocarbons obtained by distillation of crude oil, or chemically synthesized hydrocarbons which have a flush point of from 21° C. to less than 200° C. and a molecular weight of 200 or less.

3. The curable composition according to claim 1 or 2, wherein the adhesion promoter is a combination of an epoxy resin and a latent curing agent.
